(19) United States
(12) Patent Application Publication
(10) Pub. No.: US 2020/0317112 A1
(43) Pub. Date: Oct. 8, 2020

(54) Tailgate Protection Device

(71) Applicant: Jon Bickerton, Kitchener (CA)

(72) Inventor: Jon Bickerton, Kitchener (CA)

(21) Appl. No.: 16/377,231

(22) Filed: Apr. 7, 2019

(51) Int. Cl. B60P 7/135; B60P 1/64; B60R 9/06

(52) U.S. Cl. CPC B60P 7/135; B60R 9/06; B60P 1/6409

(57) ABSTRACT

An apparatus for protecting a tailgate portion of a truck have a truck bed is disclosed. This apparatus comprises a protection bar, at least two support tubes and at least two mounting tubes. The protection bar has a first protection bar end and a second protection bar end. Each of the support tubes have having a straight insertion portion, a protection bar receiving portion and a curved portion therebetween. The protection bar receiving portions are configured to receive one end of the protection bar. Each curved portion is configured to curve above and over the tailgate. Each of the mounting tubes have an open mounting tube first end, an open mounting tube second end, and four mounting tube side walls. The mounting tubes are configured to slidably receive the insertion portion of a support tube. Further, each mounting tube is configured to be secured to an interior side wall of a truck bed.

### REFERENCE TO PENDING APPLICATIONS

This application does not claim the benefit of any issued U.S. Patent or pending application.

### BACKGROUND OF THE INVENTION

### Field of the Invention

The present invention relates generally to cargo securing devices, and in particular to a tailgate protection device commonly installed on a truck.

### Background

Several types of ladder rack/tail gate protectors are in use and known in the prior art. However, many of these devices are difficult to use, inefficient, or eventually cause damage to the truck bed. These devices also require that the user utilize straps to secure a load within the truck bed. These straps can fail causing the load to fall.

U.S. Pat. Pub. No. 20170036615 issued to Sayegh discloses a three-dimensional rack useful in a pick-up truck or trailer having a bed with raised vertical side walls and a hinged rear tailgate. The rack has a first crossbar the ends of which are pivotally received at the opposed inside walls of the truck or trailer bed, a pair of matched spaced apart arms affixed to the first crossbar and a second crossbar affixed to said pair of arms, the arms being shaped so that the crossbars are horizontally and vertically displaced from each other while being parallel to each other.

U.S. Pat. No. 5,494,327 issued to Derecktor is discloses a sliding connection especially suited for releasably and adjustably attaching an overhead rack or the like to side walls of a pickup truck includes a track mountable on the side wall of the pickup truck, and a sliding lock assembly releasably attachable to the rail member. The track includes an elongate tubular body having a bottom surface engagable with the side wall of the pickup truck and a top surface opposite the bottom surface, and a plurality of rail members integrally formed with the tubular body and extendable along the length of the body. The sliding lock assembly includes, in one embodiment, a sliding lock member slidably mounted on the rail member of the track and movable along the length of the rail member, and a thumb turn for locking the sliding lock member at a desired position along the length of the rail member.

U.S. Pat. No. 7,044,699 issued to St. Denis discloses an adjustable load stabilizer secures loads of any size within the width of the track carried in a cargo bed of a truck or SUV and which extend beyond the vehicle tailgate, while not interfering with the operation of the tailgate or cargo bed when permanently installed. The load stabilizer comprises two brackets which are mounted to the vehicle tailgate and which support a traversing track which is offset from the tailgate by 3 inches, mounted parallel to and lower than the top of the tailgate. Two travelling arm carriers move freely along the length of the traversing track, each supporting a collapsible arm. The travelling arm carriers are moved into position to stabilize the extended load and the collapsible arms are then raised. Raising the collapsible arms creates an interference fit with the traversing track thus securing the arms in the upright position. The arms thus prevent the extended load from sliding around the cargo bed during transport.

U.S. Pat. No. 7,513,726 issued to Comiskey, Jr. discloses a tailgate protector (1) having a structural frame (3) combined with a plurality of spaced protrusions (2). The structural frame (3) is sized and shaped to mount to the upper edge of a closed vehicle tailgate, such that the protrusions (2) perpendicularly extend above the upper edge of the tailgate. Material being transported by the vehicle and supported by the tailgate upper edge is placed on the structural frame (3) within the spacings between the protrusions (2). The structural frame (3) acts to protect the surface of the tailgate edge, while the protrusions (2) restrict the side to side movement of the transported material. Thus, the tailgate protector (1) effectively provides a quick and convenient means for securing the transported material while protecting the tailgate edge.

U.S. Pat. No. 4,650,383 issued to Phillip L. Hoff discloses a cargo stabilizer is provided for utility vehicles, such as vans, pickup trucks, and the like, which have a cargo carrying bed. The stabilizer prevents the cargo from shifting either fore-to-aft or laterally in the vehicle bed. The stabilizer comprises two guide rails attached lengthwise along the opposite sidewalls of the vehicle bed in a generally mutually parallel relationship. A crossbar is slidingly supported on the guide rails, and includes latches at the opposite ends of the crossbar to adjustably and positively connect the crossbar to the guide rails at a selected location. The crossbar is longitudinally adjustable between locked and unlocked positions, and includes abutment surfaces at its opposite ends which directly abut the sidewalls of the vehicle bed when the crossbar is in the locked position. Hence, substantially all laterally directed stabilizing forces that develop in retaining the cargo in its selected position are transferred directly to the sidewalls of the vehicle's bed, and do not on the guide rails themselves, thereby providing very secure stabilizing support, without requiring a heavy-duty stabilizer construction.

U.S. Pat. No. 6,168,359 issued to Jeff Smith discloses a device for securing a load on the flat bed of a truck having sidewalls or other vehicle having a like cargo area. One exemplary embodiment of the present invention comprises a base member having rods extending substantially vertically therefrom. Adjustable side connectors are coupled to the base member at one or both sides of the base member in order to secure the base member to the side walls of the flat bed. A slide bar is adjustably displaced along the length of the rods to adapt to loads of varying height. The slide bar serves to secure and to stabilize the load. A fastener directs the slide bar against the load and toward the base member. Thus, the slide bar acts in a clamp-like manner to secure a load within the flat bed area of a vehicle. The present invention further comprises extension elements which enable the side connectors to be engaged to the sidewalls of the flat bed at varying heights depending on the construction of the vehicle. A lower end of each extension element is secured to the end of the base member and the side connectors couple with an upper end of the extension element at one or more locations so that the base member may engage the sidewalls of the flat bed at varying heights. In another exemplary embodiment of the present invention, a system is disclosed including a double base member and slide bar arrangement which form a dual clamp assembly. This system is implemented by placing a pair base member/slide bar assemblies on the flat bed of a truck at a given distance apart to accommodate for the length of a load. The double assembly acts to secure both ends of a load, such as lumber. When used in this manner, the invention prevents a load from shifting while the vehicle is in motion.

U.S. Pat. No. US issued to Francis Phillip Bacon discloses a tail gate load organizing device is provided for carrying items longer than a pickup truck box floor with a tailgate down by moving a supporting point out onto the tailgate. The device includes an elongated base, vertical load partitions, base support system, and a tailgate attachment member. In use, the load organizing device is mountedly placed upon a tailgate and the attachment member is extended to bring about attaching engagement with a tailgate support which extendedly connects at one end to the tailgate and at another end to the pickup truck box side. The device is then useful in loading a pickup truck by causing an organized elongated load to be maintained within a pickup truck box and inclined relative to the floor of the truck box.

U.S. Pat. No. 7,156,592 issued to Stephen J. Cava discloses an apparatus for controlling a load in a vehicle, particularly a pickup truck where the load is longer than the bed of the truck. The apparatus comprises a channel mounted to or defined by the bed or tailgate of the truck. A load-restraining member slidably engages the channel to adjust for loads of different sizes. The load-restraining member also rotatably engages the channel and may move between an upright position for use and a horizontal position for storage. The load-restraining member may be secured in the upright position.

U.S. Pat. Pub. No. 20080079277 issued to Brian Wethington discloses a rack assembly for at least partially supporting a ladder in the bed box of a truck is disclosed herein. The rack assembly includes a telescopically erectable and collapsible stanchion assembly, at least one bracket assembly for mounting the bottom of the stanchion assembly to the truck's bed box, and a telescopically extendable and retractable crossbar assembly that is releasably securable at the top of the stanchion assembly. When the rack assembly is not being used, tubular sections of the stanchion assembly can be telescopically collapsed together. Tubular sections of the crossbar assembly can be released from the top of the stanchion assembly and then placed in the collapsed stanchion assembly. In this way, the rack assembly can be stored in a substantially unitary, reduced-volume configuration in the bed box of the truck.

U.S. Pat. Pub. No. 20090255966 issued to Vuthisit Prapavat discloses a device for adjustably holding a rack in the bed of a pickup truck where the rack is of the type having a vertical support and that is inserted into a base attached to the floor of the pickup truck bed. The adjustable device comprises a first metal plate, adapted to be fixed to the upper flat surface of the pickup truck side, and a second metal plate, having a groove in one side, that is slidably connected to the first plate using one or more bolts. The second metal plate has a vertical sleeve through which the vertical support of the rack is placed prior to connecting to the base plate. The position of the second plate is adjustable either in the direction of travel or perpendicular to the direction of travel of the vehicle, by selecting the angular position of the sleeve about its axis, thereby adjusting the position of the rack in either of the two directions.

### BRIEF SUMMARY OF THE INVENTION

The inventive concept is directed toward a cargo securing devices, and in particular to a device relating to a ladder rack/tail gate protector commonly installed on a truck.

In one aspect, the device includes a protection bar, at least two support tubes, and at least two mounting tubes. The protection bar may have a first protection bar end and a second protection bar end. Each of the support tubes may have a straight insertion portion, a protection bar receiving portion and a curved portion therebetween. Each protection bar receiving portion may be configured to receive one end of the protection bar. Each curved portion may be configured to curve above and over the tailgate. Each mounting tube may have an open mounting tube first end, an open mounting tube second end, and four mounting tube side walls. Each mounting tube may be configured to slidably receive the insertion portion of a support tube. Each mounting tube may be configured to be secured to an interior side wall of a truck bed.

In other aspects, the protection bar may have a square dimension. Further, each mounting tube may have a square tubular dimension. Still further, the device may have at least one mounting bracket for each mounting tube for securing the mounting tube to the interior side wall of the truck bed. Still further, each insertion portion and each mounting tube may have mounting alignment holes to provide alignment and to secure each support tube within a respective mounting tube, along with one or more alignment pins for placement within one or more of the alignment hole. Still further, each protection bar end and each protection bar receiving portion may have protection bar securing holes to secure each protection bar end to a protection bar receiving portion, along with one or more securing pins for placement within one or more protection bar securing holes to secure the protection bar to each support tube.

In one aspect of its operation, the device may slide into a bracket secured within a truck bed. The device may hang over and/or above the vehicle's tailgate providing protecting to that vehicle. The device may also raise to parallel to a front ladder rack allowing all access within the bed of truck. Further, the device may be secured to the tailgate to allow for ease of securing loads without the need for straps.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a side prospective view of an embodiment of the present invention.

FIG. 2 is a front prospective view of an embodiment of the present invention.

FIG. 3 is a front view of an embodiment of the present invention.

FIG. 4 is a side view of an embodiment of the present invention.

FIG. 5 is a front view of an embodiment of the mounting tube of the present invention.

FIG. 6 is a front view of an embodiment of the support tube of the present invention.

FIG. 7 is a side view of an embodiment of the support tube of the present invention.

FIG. 8 is a top view of an embodiment of the protection bar of the present invention.

FIG. 9 is a top view of an embodiment of the support tube of the present invention.

FIG. 10 is a top view of an embodiment of the protection bar engaging the support tube of the present invention.

FIG. 11 is a front view of an embodiment of the protection bar engaging the support tube of the present invention.

### DETAILED DESCRIPTION FO THE INVENTION

The inventive concept is directed toward a cargo securing devices, and in particular to a device relating to a ladder rack/tail gate protector commonly installed on a truck.

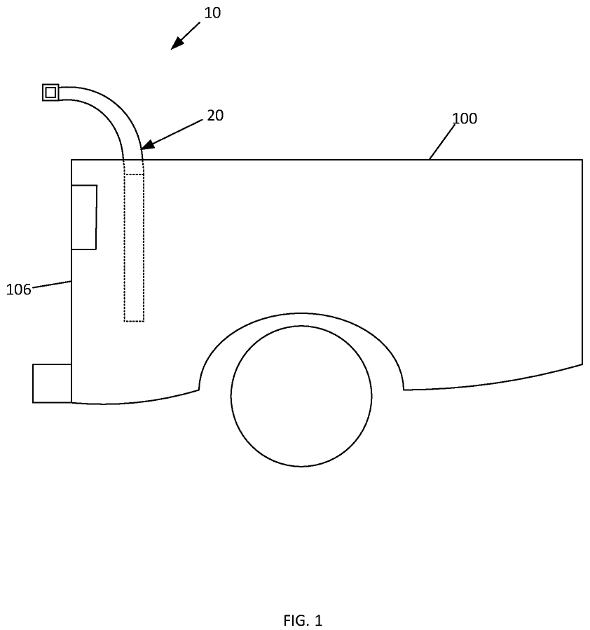

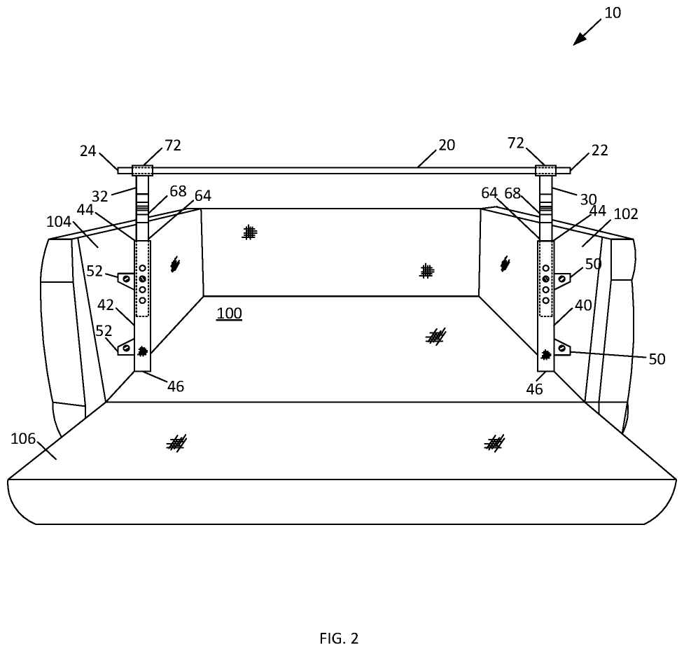

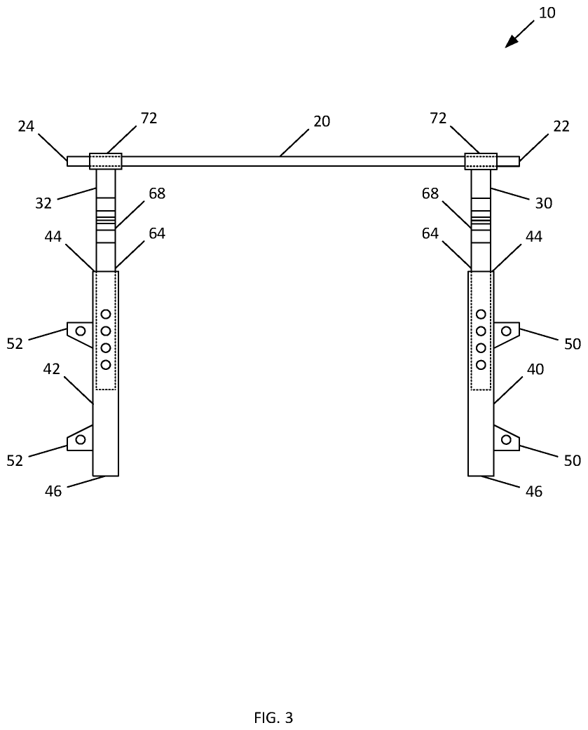

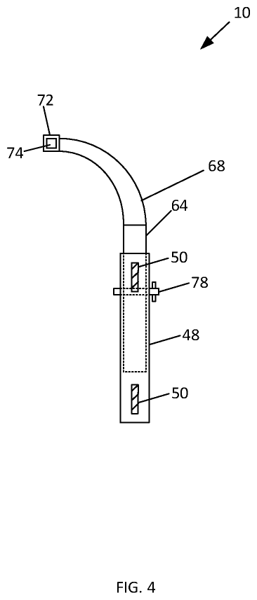

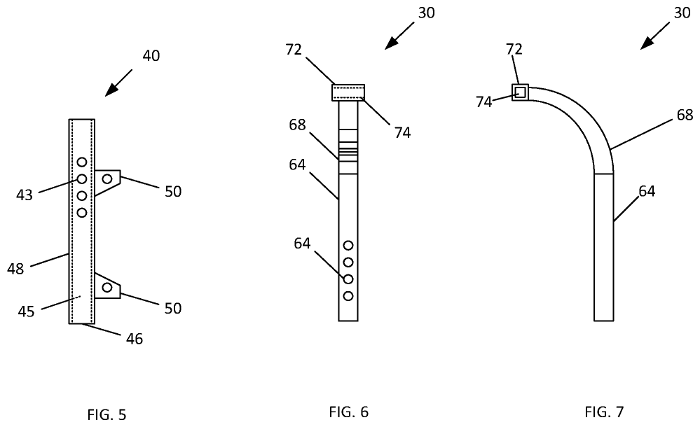

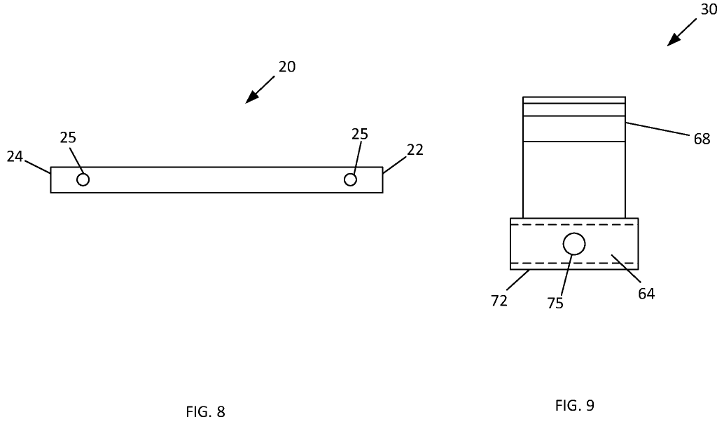

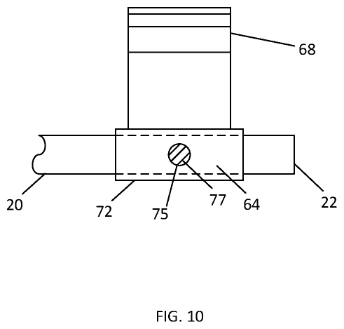

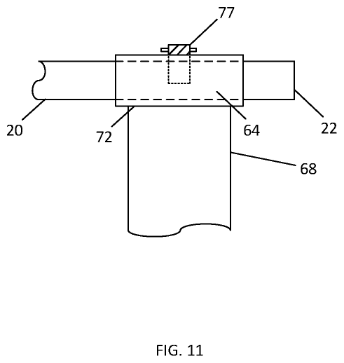

As shown in FIGS. 1-11, an embodiment of the present invention is disclosed, device 10 includes a protection bar 20, a first support tube 30, a second support tube 32, a first mounting tube 40 and a second mounting tube 42. Protection bar 20 has a square dimension and has a first protection bar end 22 and a second protection bar end 24. In this embodiment, the support tubes, 30, 32, mounting tubes 40, 42 and protection bar 20 is illustrated having a square dimension. Those skilled in the art will recognize other configurations may be utilized and are in the scope of the present invention. One such alternative configuration would include a round dimension along the interior portion of the protection bar with a square dimension near and at its ends. Further, various FIGS. illustrate a single support tube and/or mounting tube. This is illustrative as the first and second support tubes and mounting tubes are practically identical. As such, the description for one support tube and/or mounting tube would apply to the other tubes.

Each mounting tube 40, 42 has a square tubular dimension and configured to slidably receive first and second support tubes 30, 32 respectively through an opening 45 therethrough. Further, each mounting tube 40, 42 has an open mounting tube first end 44, an open mounting tube second end 46, and four mounting tube side walls 48. Mounting brackets 50, 52 are attached to side walls of the first and second mounting tubes 40, 42 respectfully. First mounting tube 40 is secured to the interior side wall 102 of a truck bed 100 along the driver's side proximate to the tailgate 106. Second mounting tube 42 is securing to the interior side wall 104 of truck bed 100 along the passenger's side proximate to tailgate 106. Both mounting tubes 40, 42 are secured to the interior side walls by first and a second mounting brackets 52, 50.

Each support tube 30, 32 has a straight insertion portion 64, a protection bar receiving portion 72 and a curved portion 68 therebetween. Each insertion portion 64 and curved portion 68 has a square tubular configuration. Each protection bar receiving portion 72 is configured to receive one end of protection bar 20 through a protection bar opening 74 therethrough. Both insertion portions 64 are dimensioned to freely move through mounting tubes 40, 42. Insertion portions 64 and mounting tubes 40, 42 have mounting alignment holes 43 and 67 respectively. As insertion portions 64 are moved axially within mounting tubes 40, 42 alignment holes 43, 67 align at which point a securing pin 78 may be inserted through the support tube and insertion portion holes thereby locking each support tube 30, 32 at a desired height. Curved portions 68 respectively are configured to curve above and over tailgate 106.

In this embodiment, protection bar 20 is dimensioned to freely move through protection bar receiving opening 74. Protection bar ends 22, 24 and protection bar receiving portions 72 have protection bar securing holes 25 and 75 respectively. As protection bar ends 22, 24 are moved axially within protection bar receiving portions 72 protection bar securing holes 25 and 75 align at which point a protection bar securing pin 77 may be inserted through protection bar securing holes 25 and 75 thereby locking protection bar 20 to each support tube 30, 32.

In operation, protective bar 20 is secured to both support tubes 30, 32, while both support tubes 30, 32 are secured to both mounting tubes 40, 42 respectively.

Support tubes 30, 32 are secured within mounting tubes 40 ,42 such that curve portions 68 extend above and over tailgate 106 at a desired height. Protective bar 20 extends between both support tubes 30, 32. Due to its height above tailgate 106, it is capable of bearing a load, such as a ladder, a tool or other items, thereby removing the load from the tailgate.

While preferred embodiments of the present inventive concept have been shown and disclosed herein, it will be obvious to those persons skilled in the art that such embodiments are presented by way of example only, and not as a limitation to the scope of the inventive concept. Variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, and by no means limited by the scope of the claims presented herein.

I claim:

1. An apparatus for protecting a tailgate portion of a truck have a truck bed comprising:
a protection bar having a first protection bar end and a second protection bar end;
at least two support tubes, each support tube having a straight insertion portion, a protection bar receiving portion and a curved portion therebetween, each protection bar receiving portion configured to receive one end of the protection bar, each curved portion configured to curve above and over the tailgate; and
at least two mounting tubes, each mounting tube having an open mounting tube first end, an open mounting tube second end, and four mounting tube side walls, each mounting tube being configured to slidably receive the insertion portion of a support tube, each mounting tube being configured to be secured to an interior side wall of a truck bed.

2. The apparatus of claim 1 wherein protection bar has a square dimension.

3. The apparatus of claim 1 wherein each mounting tube has a square tubular dimension.

4. The apparatus of claim 1 further comprising at least one mounting bracket for each mounting tube for securing the mounting tube to the interior side wall of the truck bed.

5. The apparatus of claim 1, wherein each insertion portions and each mounting tubes have mounting alignment holes to provide alignment and to secure each support tube within a respective mounting tube.

6. The apparatus of claim 5, further comprising one or more alignment pins for placement within one or more of the alignment hole for aligning and securing each support tube within a respective mounting tube.

7. The apparatus of claim 1, wherein each protection bar ends and each protection bar receiving portions have protection bar securing holes to secure each protection bar end to a protection bar receiving portion.

8. The apparatus of claim 7, further comprising one or more securing pins for placement within one or more protection bar securing holes to secure the protection bar to each support tube.
